(19) United States
(12) Patent Application Publication
(10) Pub. No.: US 2007/0085423 A1
(43) Pub. Date: Apr. 19, 2007

(54) Window control switch system for vehicles

(75) Inventor: Kyu-Hwan Chin, Gyeonggi-do (KR)

Correspondence Address: EDWARDS & ANGELL, LLP, P.O. BOX 55874, BOSTON, MA, 02205, US

(73) Assignee: Hyundai Motor Company, Seoul (KR)

(21) Appl. No.: 11/296,801

(22) Filed: Dec. 6, 2005

(30) Foreign Application Priority Data
Oct. 19, 2005 (KR) 10-2005-0098423

(51) Int. Cl. H01F 13/00

(52) U.S. Cl. 307/101

(57) ABSTRACT

Window control switch system for vehicles are provided that preferably comprise a single switch module which can control manipulation of at least two of i) one or more vehicle windows, ii) one or more vehicle doors and iii) one or more vehicle mirror. Preferred systems also comprise a control module that can receive a signal from the switch module and outputs a control signal to manipulate windows, doors and/or mirrors of a vehicle. Preferred systems also may comprise a cluster module which includes a display unit for receiving a manipulation signal, transmitted from the switch module, through the control module and for displaying a corresponding driving control item, and transmits a current selection mode to the control module.

### CROSS-REFERENCE TO RELATED APPLICATIONS

The present application is based on, and claims priority from, Korean Application Serial Number 10-2005-0098423, filed on Oct. 19, 2005, the disclosure of which is hereby incorporated by reference herein in its entirety.

### FIELD OF THE INVENTION

The present invention relates to window control switch systems for vehicles and, more particularly, to a window control switch system for vehicles, in which switches respectively required to control the driving of power windows, door locking/unlocking and mirrors of a vehicle are integrated into a single switch.

### BACKGROUND OF THE INVENTION

The structure of a conventional power window switch for vehicles is designed to perform a single function using a single switch. That is, a power window switch, a door locking/unlocking switch, a window locking/unlocking switch and a mirror control switch, all of which are distinct, separate switches, perform only their respective single functions.

Therefore, the number of switches increases as more features are provided, and an additional switch must be provided to add an additional manipulation function. Therefore, a conventional switch structure is problematic as a significant possibility exists that the multiple switches will result in confusion and mishandling by a driver, and costs will rise due to the increase in the number of switches. Further, switches often must be mounted on the trim of a door for convenience of manipulation. However, if the number of switches increases, the size of an entire switch module increases, so that the design of the trim of a door is limited.

The information set forth in this Background of the Invention section is only for enhancement of understanding of the invention and should not be taken as an acknowledgement or any form of suggestion that this information forms the prior art that is already known to a person skilled in the art.

### SUMMARY OF THE INVENTION

In one aspect, a window control switch system for vehicles is provided, in which a plurality of switches for controlling or adjusting the driving or operation of power windows, door locking/unlocking and/or mirrors of a vehicle is integrated into a single switch module. Such switch systems of the invention can offer notable advantages, including simplifying the construction of switches and improving ease of manipulation of a switch by a user.

In further aspects, a window control switch system for vehicles is provided, which displays manipulation status based on the manipulation of a switch through a monitor such as an LCD monitor provided in a module such as a cluster module, thus providing to a driver the status of selection of a switch function and the status of a control operation based on the selection of a switch function.

Preferred window control switch systems of the invention may comprise a single switch module, a control module and a cluster module. The single switch module is suitably adapted to be manipulated to control operation of at least two of windows, doors and/or mirrors of a vehicle. The control module suitably receives a signal from the switch module and outputs a control signal to control driving of the windows, the doors or the mirrors. The cluster module may suitably include a display unit for receiving a manipulation signal, transmitted from the switch module, through the control module and for displaying a corresponding driving control item, and transmit a current selection mode to the control module.

The invention also includes vehicles including motor vehicles such as automobiles that comprise one ore more window control switch systems as described herein.

It is understood that the term “vehicle” or “vehicular” or other similar terms as used herein is inclusive of motor vehicles in general such as passenger automobiles, buses, trucks, various commercial vehicles, watercraft including a variety of boats, aircraft, and the like.

Other aspects of the invention are discussed below.

### BRIEF DESCRIPTION OF THE DRAWINGS

For a better understanding of the nature and objects of the present invention, reference should be made to the following detailed description with the accompanying drawings, in which:

FIG. 1 illustrates the construction of a preferred window control switch system for vehicles according to the present invention;

FIG. 2a is a front view of the switch module of the system according to the present invention;

FIG. 2b is a side view of the switch module of the system according to the present invention; and

FIG. 3 illustrates a control screen provided through the display unit of the cluster module of the system according to the present invention.

### DETAILED DESCRIPTION OF THE PREFERRED EMBODIMENTS

As discussed above, control switch system for a vehicle are provided which comprise a single switch module which can control manipulation (adjustment) of at least two of i) one or more vehicle windows, ii) one or more vehicle door and iii) one or more vehicle mirrors. Preferably, the single switch module can control adjustment of each of i) one or more vehicle windows, ii) one or more vehicle doors and iii) one or more vehicle mirrors. A wide variety of adjustments may be suitably made via the single module including e.g. opening and closing one or more vehicle windows, locking and unlocking one or more vehicle windows, locking and unlocking one or more vehicle doors, and moving one more vehicle mirrors which be positioned in the vehicle interior or exterior.

Preferred control switch system also may comprise a control module for receiving a signal from the switch module and outputting a control signal to manipulate at least two of i) one or more vehicle windows, ii) one or more vehicle doors and iii) one or more vehicle mirrors.

Preferred control switch system also may comprise a cluster module comprising a display unit for receiving a manipulation signal, transmitted from the switch module, through the control module and displaying a corresponding driving control item, whereby the cluster module can transmit a current selection mode to the control module.

A preferred embodiment of the present invention is now described with reference to the accompanying drawings.

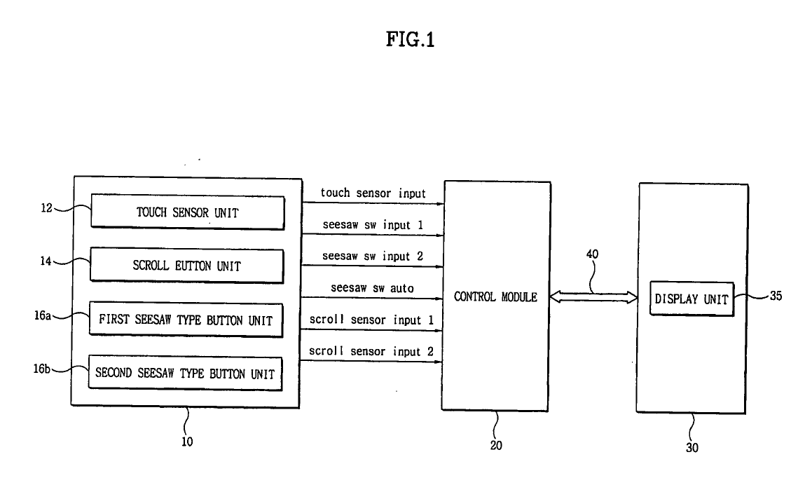

The construction of a window control switch system for vehicles according to an embodiment of the present invention is described with reference to FIG. 1.

As shown in FIG. 1, the system according to a preferred embodiment of the present invention includes a single switch module 10, a control module 20 and a cluster module 30. The single switch module 10 is manipulated to control the adjustment of one or more windows, one or more doors and/or one or more mirrors of a vehicle. The control module 20 receives a signal from the switch module 10 and outputs a control signal for controlling the adjustment or other manipulation of such windows, doors or mirrors. The cluster module 30 suitably includes a display unit 35 for receiving a manipulation signal, transmitted from the switch module 10, through the control module 20 and for displaying a corresponding driving control item, and transmits a current selection mode to the control module 20.

In such a configuration, the control module 20 and the cluster module 30 preferably perform data transmission through a Controller Area Network (CAN) bus line 40.

Further, the display unit 35 in the cluster module 30 is preferably a Liquid Crystal Display (LCD) panel.

Further, the switch module 10 is preferably installed on a driver side of a vehicle, particularly a driver side door armrest for convenience of manipulation by the driver.

Further, the switch module 10 suitably includes a touch sensor unit 12, a scroll button unit 14, and first and second seesaw type button units 16a and 16b. The touch sensor unit 12 can be manipulated to control the adjustment of windows, doors and/or mirrors of a vehicle. The scroll button unit 14 is manipulated to select a control item displayed on the display unit 35 in the cluster module 30 after the touch sensor unit 12 has been manipulated. The first and second seesaw type button units 16a and 16b can be manipulated after a selection bar is located on a corresponding control item by the manipulation of the scroll button unit 14. The first seesaw type button unit 16a is manipulated to perform functions, such as window raising, door locking, window locking, the outward and downward rotation of left/right side rear view mirrors, and the folding of the left/right side rear view mirrors, and the second seesaw type button unit 16b is manipulated to perform functions, such as window lowering, door unlocking, window unlocking, the inward and upward rotation of the left/right side rear view mirrors, and the unfolding of the left/right side rear view mirrors.

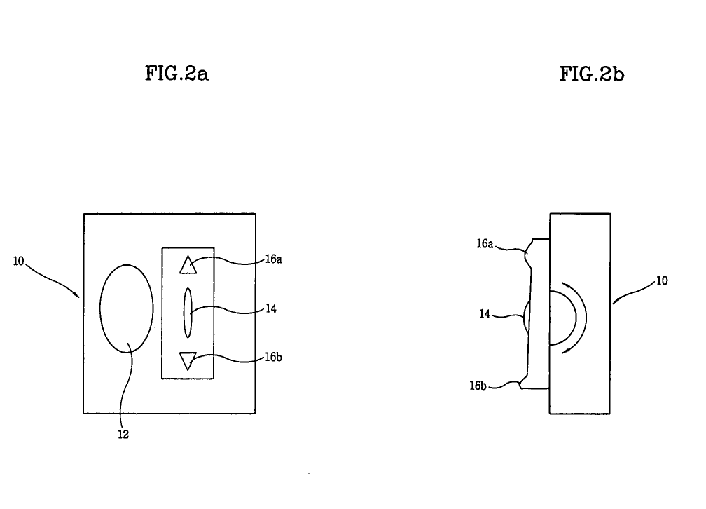

A detailed construction of the preferred switch module 10 is shown in FIGS. 2a and 2b. FIG. 2a is a front view of the switch module, and FIG. 2b is a side view of the switch module.

As shown in FIGS. 2a and 2b, the touch sensor unit 12, which is manipulated to control the driving of windows, doors and/or mirrors of a vehicle, is located in the switch module 10. In the switch module 10, the scroll button unit 14, which is manipulated to select a control item after the touch sensor unit 12 has been manipulated, is suitably located beside the touch sensor unit 12, and the first and second seesaw type button units 16a and 16b are located above and below the scroll button unit 14.

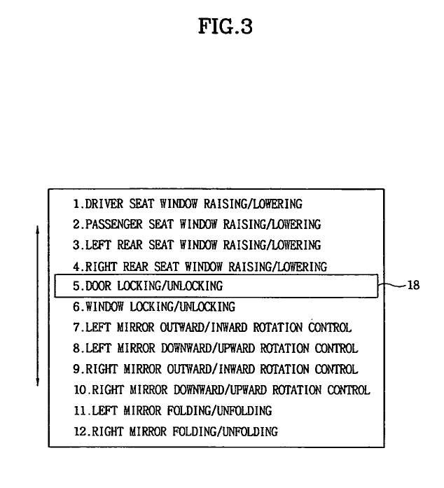

A control item selected through the scroll button unit is suitably displayed through the display unit in the cluster module, as shown in FIG. 3.

A control screen provided through the display unit in the cluster module is displayed to identify a control item using a selection bar 18. On the displayed control screen, menu items are provided, such as the raising/lowering of the windows of a driver seat, a passenger seat, a left rear seat and a right rear seat, door locking/unlocking, window locking/unlocking, the control of outward/inward rotation of a left side rear view mirror, the control of downward/upward rotation of the left side rear view mirror, the control of outward/inward rotation of a right side rear view mirror, the control of downward/upward rotation of the right side rear view mirror, the folding/unfolding of the left side rear view mirror, and the folding/unfolding of the right side rear view mirror.

A window control switch system for vehicles as generally described in FIG. 1 can be suitably operated as follows.

First, if a driver touches the touch sensor unit 12 to control the raising/lowering of the power windows of a vehicle, the locking/unlocking of doors or the driving of mirrors, the control screen of FIG. 3 is provided through the display unit 35 in the cluster module 30.

In this state, the driver can manipulate the scroll button unit 14 and then select a required function to be manipulated from the provided control screen. The detailed control of the selected function is performed by manipulating a corresponding button provided in the first and second seesaw type button units 16a and 16b, as described above. Such a selection function is suitably provided to the driver in real time through the display unit 35 in the cluster module 30 that communicates with the control module 20 through the CAN bus 40. In the above operation, as manipulation signals transmitted from the switch module 10 to the control module 20, a touch sensor manipulation signal (touch sensor input), first and second seesaw type button manipulation signals (seesaw sw input 1 and 2) and scroll button manipulation signal (scroll sensor input 1 and 2) are applied. In FIG. 1, an automatic seesaw signal (seesaw sw auto) is a signal required to automatically operate the raising/lowering of power windows.

As described above, the control module 20 transmits a manipulation signal, received from the switch module 10, to the cluster module 30, thus enabling the manipulation signal to be displayed through the cluster module 30. The cluster module 30 transmits a current selection mode to the control module 20, thus performing a corresponding function in response to a control signal output from the control module 20. The manipulation of windows, doors and mirrors is suitably accomplished in response to the control signal output from the control module 20.

Thus, new systems are provided that integrate respective switches for controlling the manipulation of power windows, the locking/unlocking of doors and/or the adjustment of mirrors for vehicles into a single switch module.

It should be appreciated that preferred systems of the invention can provide significant advantages.

For instance, relative to prior systems, the number of separate switches can be reduced. Among other things, this can reduce the probability of erroneous operation of the switch system by a driver, thereby providing ease of operation and increased safety.

Additionally, the size of a switch module can be reduced, thereby facilitating convenient mounting of the switch module within a vehicle such as on the trim of a vehicle door.

Also, in preferred systems the manipulation status can be displayed on a cluster for convenient viewing by a vehicle operator, which further aids the driver's ability to manipulate switches as desired.

While the invention has been described with reference to specific embodiments, modifications and variations may be constructed without departing from the scope of the invention, which is defined in the following claims.

What is claimed is:

1. A control switch system for a vehicle, comprising:
a single switch module adapted to be manipulated to control adjustment of windows, doors and mirrors of a vehicle;
a control module for receiving a signal from the switch module and outputting a control signal to control driving of the windows, the doors or the mirrors; and
a cluster module including a display unit for receiving a manipulation signal, transmitted from the switch module, through the control module and displaying a corresponding driving control item, the cluster module transmitting a current selection mode to the control module.

2. The window control switch system for vehicles as defined in claim 1, wherein the switch module comprises:
a touch sensor unit adapted to be manipulated to control adjustment of the windows, the doors and the mirrors of the vehicle;
a scroll button unit adapted to be manipulated to select a control item displayed on the display unit in the cluster module after the touch sensor unit has been manipulated;
first and second seesaw type button units adapted to be manipulated after a selection bar is located on a corresponding control item by the manipulation of the scroll button unit, the first seesaw type button unit being manipulated to perform functions such as window raising, door locking, window locking, outward and downward rotation of left/right side rear view mirrors, and folding of the left/right side rear view mirrors, the second seesaw type button unit being manipulated to perform functions such as window lowering, door unlocking, window unlocking, inward and upward rotation of the left/right side rear view mirrors, and unfolding of the left/right side rear view mirrors.

3. The window control switch system for vehicles as defined in claim 1, wherein the control module and the cluster module perform data transmission through a Controller Area Network (CAN) bus line.

4. The window control switch system for vehicles as defined in claim 1, wherein the display unit in the cluster module is a Liquid Crystal Display panel.

5. The window control switch system for vehicles as defined in claim 4, wherein the display unit in the cluster module provides a control screen providing functions, including raising/lowering of windows of a driver seat, a passenger seat, a left rear seat and a right rear seat, door locking/unlocking, window locking/unlocking, control of outward/inward rotation of a left side rear view mirror, control of downward/upward rotation of the left side rear view mirror, control of outward/inward rotation of a right side rear view mirror, control of downward/upward rotation of the right side rear view mirror, folding/unfolding of the left side rear view mirror, and folding/unfolding of the right side rear view mirror.

6. The window control switch system for vehicles as defined in claim 1, wherein the switch module is installed on a driver side door armrest of the vehicle.

7. A control switch system for a vehicle, comprising:
a single switch module which can control manipulation of at least two of i) one or more vehicle windows, ii) one or more vehicle door and iii) one or more vehicle mirrors.

8. The system of claim 7 further comprising a control module for receiving a signal from the switch module and outputting a control signal to manipulate at least two of i) vehicle windows, ii) vehicle door and iii) vehicle mirror.

9. The system of claim 8 further comprising a cluster module comprising a display unit for receiving a manipulation signal, transmitted from the switch module, through the control module and displaying a corresponding driving control item, whereby the cluster module transmits a current selection mode to the control module.

10. The system of claim 9 wherein the single switch module can control manipulation of each of i) one or more vehicle windows, ii) one or more vehicle doors and iii) one or more vehicle mirrors.

11. The system of claim 9 wherein the switch module comprises:
a touch sensor unit adapted to be manipulated to control adjusting of at least two of i) one or more vehicle windows, ii) one or more vehicle doors and iii) one or more vehicle mirrors;
a scroll button unit adapted to be manipulated to select a control item displayed on the display unit in the cluster module after the touch sensor unit has been manipulated;
first and second seesaw type button units adapted to be manipulated after a selection bar is located on a corresponding control item by the manipulation of the scroll button unit, the first seesaw type button unit being manipulated to perform functions such as window raising, door locking, window locking, outward and downward rotation of left/right side rear view mirrors, and folding of the left/right side rear view mirrors, the second seesaw type button unit being manipulated to perform functions such as window lowering, door unlocking, window unlocking, inward and upward rotation of the left/right side rear view mirrors, and unfolding of the left/right side rear view mirrors.

12. The system of claim 7 wherein the control module and the cluster module perform data transmission through a Controller Area Network (CAN) bus line.

13. The system of claim 7 wherein the switch module is installed on a driver side door armrest of a vehicle.

14. A vehicle comprising the switch system of claim 1.

15. A vehicle comprising the switch system of claim 7.
